(19) United States
(12) Patent Application Publication
(10) Pub. No.: US 2004/0129778 A1
(43) Pub. Date: Jul. 8, 2004

(54) Cashless automatic vendor system and method, and automatic vendor

(76) Inventors: Michihiro Ota, Sakado-shi (JP); Hiroaki Yoshida, Tsurugashima-shi (JP); Hiroaki Shinada, Tsurugashima-shi (JP); Akira Onodera, Kawagoe-shi (JP); Kumiko Hisai, Sakado-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/466,548

(22) PCT Filed: Nov. 14, 2002
(86) PCT No.: PCT/JP02/11866

(30) Foreign Application Priority Data
Nov. 28, 2001 (JP) 2001-362973

(51) Int. Cl. G06F 7/08

(52) U.S. Cl. 235/381

(57) ABSTRACT

A cashless automatic vendor system comprises a portable communication terminal which enables a user to dispense with troublesome operations and to execute the cashless operation of even an existing automatic vendor. An automatic vendor (1) issues a settlement request code for requesting the settlement of a selected commodity on the basis of user's operation. A center apparatus (3) processes settlement on the basis of the settlement request code received from the automatic vendor (1) via a cellular phone terminal (2), processes the settlement request code as predetermined to generated a sale permission code, and transmits it to the cellular phone terminal (2). The automatic vendor (1) reads the sale permission code displayed on the display section of the cellular phone terminal (2) and controls commodity sale on the basis of the sale permission code.

### TECHNICAL FIELD

The present invention relates to a cashless automatic vendor system and method, and automatic vendor. In particular, the present invention relates to a cashless automatic vendor system and method, and automatic vendor for performing the settlement of a sale of a commodity or a service rendered in the sale by using a portable communication terminal carried by a user.

### BACKGROUND ART

In many currently-used automatic vendors, a user purchases a desired commodity or receives a service by putting a value such as coins or a prepaid card into the venders.

However, such an automatic vendor requires a user to always carry cash or a card. Such an automatic vendor is particularly burdensome to a user when the user is required to carry a large number of prepaid cards for various types of services that the user intends to receive corresponding to each of the systems. On the other hand, such an automatic vendor causes a seller to miss a selling opportunity due to the shortage of change. An automatic vendor in which a card can be used needs to install therein a cad reader/writer and requires the issue of a large number of cards, thus requiring vast amounts of time and cost.

Recently, small and high-performance portable communication terminals such as mobile phone, personal handyphone system (PHS) have been widely used, and a cashless system for an automatic vendor using these communication terminals has been devised.

However, the cashless system using the aforementioned conventional portable communication terminal requires a user to go through a complicated operation such as individual authentication, which prevents the user from purchasing a commodity easily. On the other hand, a seller is required to spend a large amount of cost for providing an on-line automatic vendor. Further, there occur problems such that the above system cannot be constructed in existing automatic vendors, which makes it difficult for the system to be widely used.

### DISCLOSURE OF THE INVENTION

In view of the foregoing, it is an object of the present invention to provide a cashless automatic vendor system and method, and automatic vendor which allow a user to perform no complicated operations, which allow even an existing automatic vendor to reform as a cashless automatic vender easily, and which provide both users and sellers with high safety and benefit.

In order to achieve the above objective, a cashless automatic vendor system of the present invention comprises an automatic vendor for selling a commodity; a portable communication terminal used for purchasing the commodity from the automatic vendor; and a center apparatus for controlling sale of the commodity from the automatic vendor using the portable communication terminal, wherein the automatic vendor comprises first code issue means for issuing a first code regarding the sale of the commodity in accordance with a request by a user; image reading means for reading a second code regarding a permission of the sale of the commodity from display means of the portable communication terminal based on the communication between the portable communication terminal and the center apparatus, the second code being issued by the center apparatus and displayed on the display means of the portable communication terminal; and sale control means for controlling the sale of the commodity based on the second code read by the image reading means, the portable communication terminal comprises input means for inputting the first code issued by the first code issue means of the automatic vendor; transmission means for transmitting the first code inputted by the input means to the center apparatus; and display means for displaying the second code issued by the center apparatus, the center apparatus comprises authentication means for authenticating the portable communication terminal based on the communication with the portable communication terminal; settlement processing means for performing a settlement processing based on the first code transmitted by the transmission means of the portable communication terminal; and a second code issue means for performing a predetermined processing for first code to generate the second code and transmitting the second code to the portable communication terminal.

In the above configuration, the second code may be any of a one-dimensional bar code, a two-dimensional bar code and a three-dimensional bar code.

Further, it may be so configured that the automatic vendor comprises a display apparatus for displaying the first code issued by the first code issue means, the portable communication terminal comprises image pick-up means which is built therein or externally connected thereto, and the input means inputs the first code by picking up an image of the first code displayed on the display apparatus of the automatic vendor by the image pick-up means.

Further, a cashless automatic vending control method of the present invention comprises a step of issuing a first code regarding a sale of a commodity from an automatic vendor in accordance with a request by a user; a step of inputting the first code issued by the automatic vendor to a portable communication terminal carried by the user; a step of transmitting the first code inputted to the portable communication terminal from the portable communication terminal to a center apparatus; a step of authenticating the portable communication terminal at the center apparatus based on the communication with the portable communication terminal; a step of performing a settlement proceeding for the sale of the commodity at the center apparatus based on the first code transmitted from the portable communication terminal; a step of subjecting the first code to a predetermined processing at the center apparatus to generate a second code regarding a sale permission of the commodity, and transmitting the second code to the portable communication terminal; a step of displaying the second code transmitted from the center apparatus on a display section of the portable communication terminal, and showing the second code to the automatic vendor; a step of reading the second code which is shown to the automatic vendor and which is displayed on the display section of the portable communication terminal by the image reading section of the automatic vendor; and a step of controlling the sale of the commodity by the automatic vendor based on the second code read by the image reading section.

Furthermore, an automatic vendor of the present invention comprises first code issue means for issuing a first code regarding sale of a commodity in accordance with a request by a user; image reading means for reading a second code regarding a permission of the sale of the commodity from display means of a portable communication terminal based on communication between the portable communication terminal and a center apparatus, the second code being issued by the center apparatus and displayed on the display means of the portable communication terminal; and sale control means for controlling the sale of the commodity based on the second code read by the image reading means.

### BRIEF DESCRIPTION OF THE DRAWINGS

FIG. 1 is a block diagram illustrating an exemplary schematic structure of a cashless automatic vendor system according to the present invention.

FIG. 2 is a block diagram illustrating an exemplary structure of the automatic vendor of FIG. 1.

FIG. 3 is a block diagram illustrating an exemplary structure of the center apparatus of FIG. 1.

FIG. 4 illustrates the flow of the processing for selling a commodity by the cashless automatic vendor system according to the present invention.

### BEST MODE FOR CARRYING OUT THE INVENTION

Hereinafter, embodiments of the cashless automatic vendor system according to the present invention will be described in detail with reference to the attached drawings.

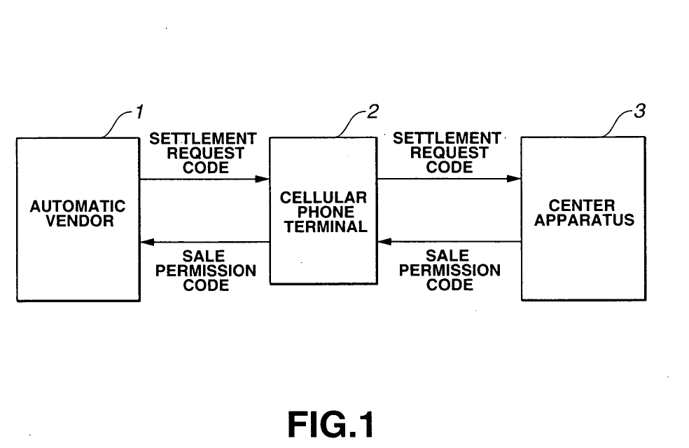

FIG. 1 is a block diagram illustrating a schematic structure of a cashless automatic vendor system according to the present invention.

In FIG. 1, the cashless automatic vendor system comprises an automatic vendor 1 for selling an article or a service; a cellular phone terminal 2 owned by a user; and a center apparatus 3 which is provided at a company that manages the automatic vendor 1 or a commodity selling agent and which is connected to a communication network such as the Internet in order to collect, store, and control the information from the cellular phone terminal 2.

In selling a commodity, the automatic vendor 1 issues a settlement request code (the first code). Then, the purchaser uses his or her cellular phone terminal 2 to send this issued settlement request code to the center apparatus 3.

Based on the settlement request code sent from the cellular phone terminal 2, the center apparatus 3 generates a sale permission code (the second code) and sends the sale permission code to the cellular phone terminal 2. The sale permission code sent from the center apparatus 3 is displayed on a display section (not shown) of the cellular phone terminal 2, and the purchaser shows the sale permission code displayed on the display section (not shown) of the cellular phone terminal 2 to the automatic vendor 1. The automatic vendor 1 reads the shown sale permission code to perform a selling processing for the commodity based on the read sale permission code.

First, the structure of the automatic vendor 1 will be described.

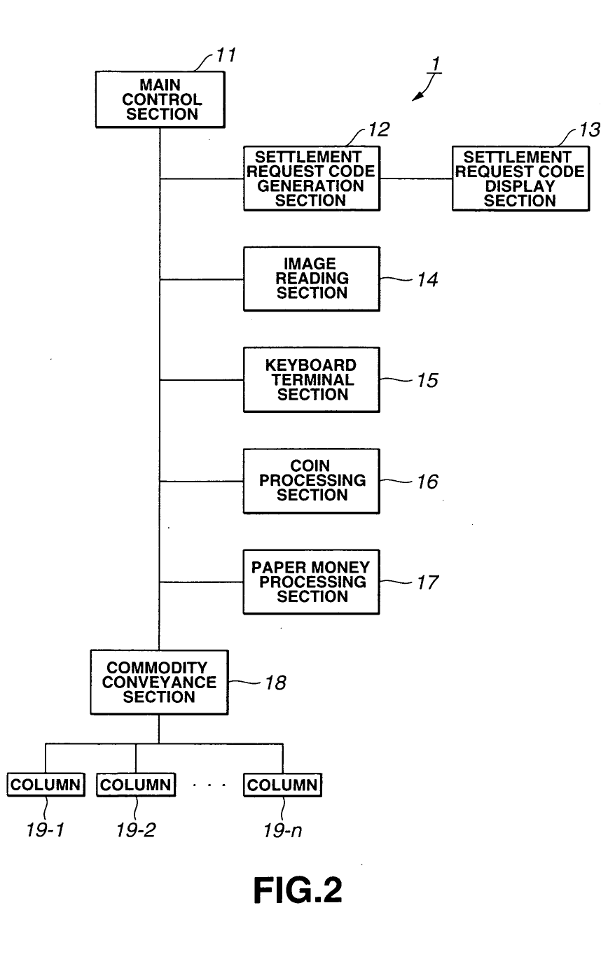

FIG. 2 is a block diagram illustrating the structure of the automatic vendor of FIG. 1.

As shown in FIG. 2, the automatic vendor 1 comprises a main control section 11; a settlement request code generation section 12; a settlement request code display section 13; an image reading section 14; a keyboard terminal section 15; a coin processing section 16; a paper money processing section 17; a commodity conveyance section 18; and columns 19 (19-1 to 19-n).

The main control section 11 controls each of the sections of the automatic vendor 1 to control the sale of a commodity and the issue of a settlement request code. Based on a control signal from the main control section 11, the settlement request code generation section 12 generates a settlement request code. This settlement request code generated by the settlement request code generation section 12 is displayed at the settlement request code display section 13 as visible information (character string, image, etc.).

The image reading section 14 reads the screen of the cellular phone terminal 2. The keyboard terminal section 15 performs various setting such as price of a commodity to be sold. The coin processing section 16 receives coins paid for a commodity and returns a change. The paper money processing section 17 performs processes such a receiving paper money. The commodity conveyance section 18 performs dispensing processes of a commodity based on the control signal from the main control section 11, and controls the dispense of the commodity stored in the column 19. Each of the columns 19 stores therein commodities.

This automatic vendor 1 can cope with two types of settlements; cash settlement and cashless settlement using the cellular phone terminal 2. When a coin slot or a paper money slot (not shown) of the automatic vendor 1 receives a coin or a paper money, the automatic vendor 1 automatically shifts to a cash settlement mode. When a user performs an operation for requesting the cashless settlement, the automatic vendor 1 shifts to the cashless settlement mode.

The operation for requesting the cashless settlement is an operation to press a cashless sale button provided in the automatic vendor 1, for example.

It is noted that, in case that only the cashless settlement using the cellular phone terminal 2 is enabled, then the coin processing section 16 and the paper money processing section 17 are unnecessary.

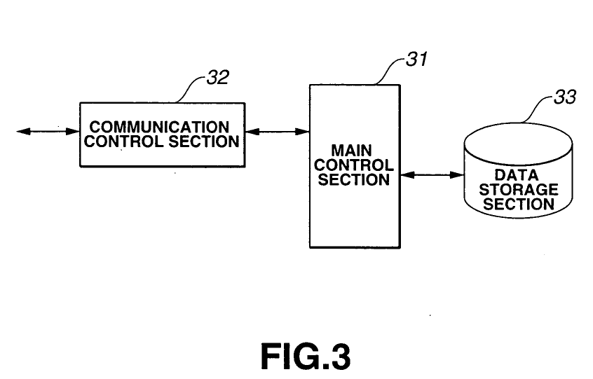

FIG. 3 is a block diagram illustrating the structure of the center apparatus 3.

As shown in FIG. 3, the center apparatus 3 comprises a main control section 31, a communication control section 32, and a data storage section 33.

The main control section 31 performs the settlement processing, etc. by controlling each section of the center apparatus 3. The communication control section 32 is connected to a network such as Internet, and controls the data exchange with the cellular phone terminal 2. The data storage section 33 stores various types of data required for the settlement processing.

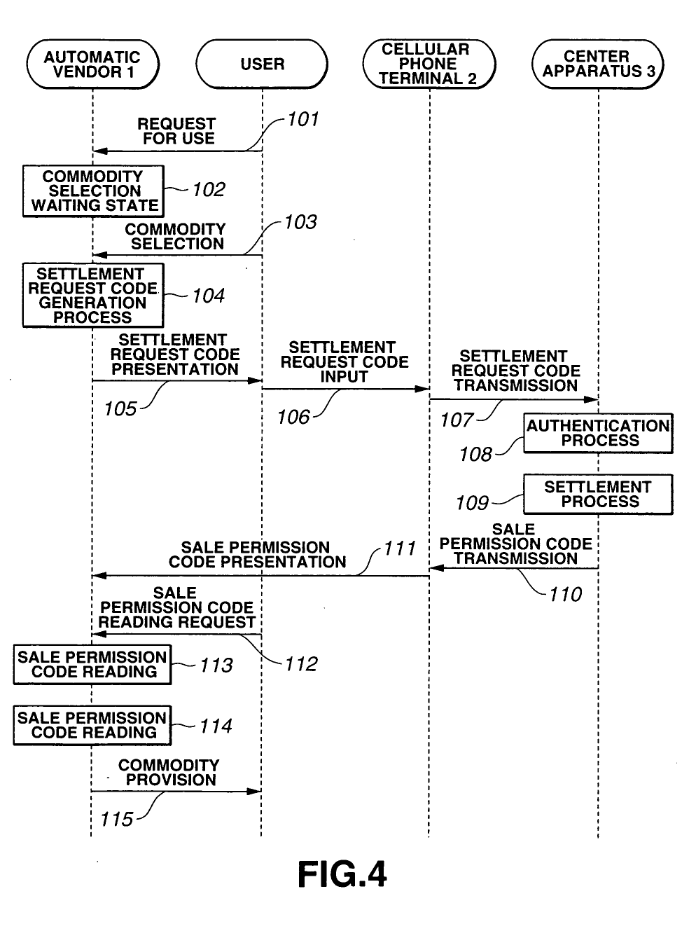

FIG. 4 illustrates the flow of the processing for selling a commodity in the cashless settlement mode.

First, when a user performs an operation for requesting the cashless settlement to the automatic vendor 1 (step 101), the automatic vendor 1 becomes in a state where the selection of a commodity by the user can be accepted (step 102). When the user selects a commodity (step 103), the automatic vendor 1 performs a settlement request code generating process (step 104).

The settlement request code includes commodity information such as type and price of selected commodity, information unique to the settlement request code, and information regarding the address of the center apparatus 3, etc. Of these information, the information unique to the settlement request code may be the one by which the settlement request code can be specified. For example, it may be a serial number which is issued each time a commodity is selected, or the combination of a random number and an identification code of the automatic vendor 1.

Having generated the settlement request code, the automatic vendor 1 visualizes the settlement request code and displays it on the display section 13 (step 105). The settlement request code is displayed as a character string including numerals, letters, symbols, or the like, or image data such as one-dimensional bar code, two-dimensional bar code. Then, the user inputs to the cellular phone terminal 2 the settlement request code displayed on the settlement request code display section 13 (step 106).

Input of the settlement request code to the cellular phone terminal 2 is performed by a key input section of the cellular phone terminal 2. Alternatively, if the cellular phone terminal 2 has a photographic function or can be used with a photography attachment, the input of the settlement request code is performed by photographing the settlement request code displayed on the settlement request code display section 13 by using the photographic function.

When the settlement request code is inputted to the cellular phone terminal 2, the cellular phone terminal 2 uses the address information of the center apparatus 3 included in this settlement request code to access the center apparatus 3, thereby transmitting a settlement request code (step 107).

Upon receiving the settlement request code, the center apparatus 3 firstly authenticates the cellular phone terminal 2 (step 108). This authentication processing is performed based on the information previously registered in the data storage section 33. After authenticating the cellular phone terminal 2, then the center apparatus 3 uses the received settlement request code to perform a settlement processing (step 109).

Methods for processing a settlement include, for example, the one in which the data storage section 33 stores the amount of money used for each user each time the settlement processing is performed, and an actual settlement is performed at a predetermined date collectively. Another method applicable is a prepaid method in which the amount of money which was previously sent from users to the management company of the automatic vendor 1 is stored in the data storage section 33 for each user, and used amount of money is deducted from this prepaid amount of money each settlement processing.

In the processing of the above settlement, the center apparatus 3 performs a predetermined processing for the settlement request code sent from the cellular phone terminal 2 to generate a sale permission code, and transmits the sale permission code to the cellular phone terminal 2 (step 110). The cellular phone terminal 2 displays the received sale permission code as visible information on the display section (not shown).

The sale permission code is displayed on the cellular phone terminal 2 as a character string including numerals, letters or symbols, or image data such as one-dimensional bar code and two-dimensional bar code.

The user shows the sale permission code displayed on the display section on the cellular phone terminal 2 to the image reading section 14 of the automatic vendor 1 (step 111), and performs operations for a request of reading the sale permission code (step 112).

The operations for a request of reading the sale permission code are performed by pressing an image reading button provided at the automatic vendor 1, for example.

Then, in response to the request of reading the sales permission code from the user, the automatic vendor 1 reads the sale permission code displayed on the display section of the cellular phone terminal 2 by the image reading section 14 (step 113), and analyzes the read sale permission code to authenticate the center apparatus 3 (step 114).

This authentication processing of the center apparatus 3 by the automatic vendor 1 is performed by performing a predetermined processing for the received sale permission code to reproduce a settlement request code, and comparing the reproduced settlement request code with the previously generated settlement request code. If they coincide each other, the automatic vendor 1 authenticates the center apparatus 3 as a proper one which produces a sale permission code from the settlement request code generated by itself by performing a proper processing.

After this authentication processing is finished, the automatic vendor 1 allows the commodity conveyance section 18 to operate, thereby providing the commodity to the user (step 115).

In case that the automatic vendor 1 cannot provide a commodity to the user due to a jamming of the commodity, for example, even when the settlement processing has been performed and the sale permission code is issued, the automatic vendor 1 may issue an error code representing that the commodity cannot be provided so that the user can use the cellular phone terminal 2 to transmit this error code to the center apparatus 3, thereby allowing the user to cancel the settlement.

Further, when the center apparatus 3 authenticates the cellular phone terminal 2 in step 108, the center apparatus 3 may request a user through the cellular phone terminal 2 to input his or her personal code number, thereby authenticating the user.

### INDUSTRIAL APPLICABILITY

According to the present invention, a user performs a cashless settlement by transmitting a settlement request code (the first code) issued by an automatic vendor to a center apparatus, receiving a sale permission code (the second code) issued by the center apparatus based on this settlement request code by the automatic vendor to allow the sale permission code be displayed on a display section of a cellular phone terminal. Then, the displayed sale permission code is read by the automatic vendor to perform a cashless settlement. This allows the user only to carry one portable communication terminal to purchase a desired article and/or to receive a desired service without having a complicated operation.

On the other hand, a seller also can avoid losing a selling opportunity due to the shortage of change and can have a cashless automatic vendor without providing the automatic vendor with an on-line function or issuing a card and providing a card reader/writer.

The present invention also can avoid complicated cash processing or the damage by a forged or altered coin or a theft or the like and can provide an easier way of managing the information regarding customers and/or sale of the commodity. The present invention also can be effectively used for a campaign using a point service or the like and/or the sale of the commodity of a commodity for which an age restriction is involved.

1. A cashless automatic vendor system, comprising:
an automatic vendor for selling a commodity;
a portable communication terminal used for purchasing the commodity from the automatic vendor; and
a center apparatus for controlling sale of the commodity from the automatic vendor using the portable communication terminal,
wherein the automatic vendor comprises:
first code issue means for issuing a first code regarding the sale of the commodity in accordance with a request by a user;
image reading means for reading a second code regarding a permission of the sale of the commodity from display means of the portable communication terminal based on the communication between the portable communication terminal and the center apparatus, the second code being issued by the center apparatus and displayed on the display means of the portable communication terminal; and
sale control means for controlling the sale of the commodity based on the second code read by the image reading means, the portable communication terminal comprises:
input means for inputting the first code issued by the first code issue means of the automatic vendor;
transmission means for transmitting the first code inputted by the input means to the center apparatus; and
display means for displaying the second code issued by the center apparatus,
the center apparatus comprises:
authentication means for authenticating the portable communication terminal based on the communication with the portable communication terminal;
settlement processing means for performing a settlement processing based on the first code transmitted by the transmission means of the portable communication terminal; and
a second code issue means for performing a predetermined processing for first code to generate the second code and transmitting the second code to the portable communication terminal.

2. The cashless automatic vendor system according to claim 1, wherein the second code is any of a one-dimensional bar code, a two-dimensional bar code and a three-dimensional bar code.

3. The cashless automatic vendor system according to claim 1, wherein
the automatic vendor comprises a display apparatus for displaying the first code issued by the first code issue means,
the portable communication terminal comprises image pick-up means which is built therein or externally connected thereto, and
the input means inputs the first code by picking up an image of the first code displayed on the display apparatus of the automatic vendor by the image pick-up means.

4. A cashless automatic vending control method, comprising:
a step of issuing a first code regarding a sale of a commodity from an automatic vendor in accordance with a request by a user;
a step of inputting the first code issued by the automatic vendor to a portable communication terminal carried by the user;
a step of transmitting the first code inputted to the portable communication terminal from the portable communication terminal to a center apparatus;
a step of authenticating the portable communication terminal at the center apparatus based on the communication with the portable communication terminal;
a step of performing a settlement proceeding for the sale of the commodity at the center apparatus based on the first code transmitted from the portable communication terminal;
a step of subjecting the first code to a predetermined processing at the center apparatus to generate a second code regarding a sale permission of the commodity, and transmitting the second code to the portable communication terminal;
a step of displaying the second code transmitted from the center apparatus on a display section of the portable communication terminal, and showing the second code to the automatic vendor;
a step of reading the second code which is shown to the automatic vendor and which is displayed on the display section of the portable communication terminal by the image reading section of the automatic vendor; and
a step of controlling the sale of the commodity by the automatic vendor based on the second code read by the image reading section.

5. The cashless automatic vending method according to claim 4, wherein the second code is any of a one-dimensional bar code, a two-dimensional bar code, and a three-dimensional bar code.

6. The cashless automatic vending method according to claim 4, wherein
the automatic vendor issues the first code by displaying the first code on the display apparatus, and
the portable communication terminal inputs the first code by picking up the first code displayed on the display apparatus of the automatic vendor by an image pick-up means which is built therein or externally connected thereto.

7. An automatic vendor, comprising:
first code issue means for issuing a first code regarding sale of a commodity in accordance with a request by a user;
image reading means for reading a second code regarding a permission of the sale of the commodity from display means of a portable communication terminal based on communication between the portable communication terminal and a center apparatus, the second code being issued by the center apparatus and displayed on the display means of the portable communication terminal; and
sale control means for controlling the sale of the commodity based on the second code read by the image reading means.

8. The automatic vendor according to claim 7, wherein the second code is any of a one-dimensional bar code, a two-dimensional bar code, and a three-dimensional bar code.
